(19) United States
(12) Patent Application Publication
(10) Pub. No.: US 2025/0090886 A1
(43) Pub. Date: Mar. 20, 2025

(54) ELECTRIC FULL BODY FITNESS EQUIPMENT

(71) Applicant: I-TECH USA, INC., Farmington Hills, MI (US)

(72) Inventor: Dominic Simenthi, Ernakulam (IN)

(21) Appl. No.: 18/409,359

(22) Filed: Jan. 10, 2024

Related U.S. Application Data
(63) Continuation-in-part of application No. 18/466,926, filed on Sep. 14, 2023.

(51) Int. Cl. A63B 21/005; A63B 21/00; A63B 24/00

(52) U.S. Cl. CPC A63B 21/0058; A63B 21/153; A63B 24/0087; A63B 2225/50

(57) ABSTRACT

The present technology provides a fitness device for use by a user. The fitness device can include a resistance assembly including a spool, a motor, a gearbox, a pulley system, and a cord. The spool can include a first end and a second end. The motor can be selectively engageable with the spool and disposed adjacent to the first end of the spool. The motor can be configured to generate a resistance force. The gearbox can be disposed between the motor and the spool. The pulley system can be disposed adjacent to the second end of the spool. The cord can be disposed on the spool and the pulley system and can be configured to be wound and unwound in a single layer on the spool when pulled by the user. The present disclosure also provides a method for using a fitness device by a user.

### CROSS-REFERENCE TO RELATED APPLICATIONS

This application is a continuation-in-part application of U.S. application Ser. No. 18/466,926, filed on Sep. 14, 2023. The entire disclosure of the above application is incorporated herein by reference.

### FIELD

The present technology relates to an electric fitness device and, more specifically, an electric resistance exercise device.

### INTRODUCTION

This section provides background information related to the present disclosure which is not necessarily prior art.

Resistance exercise devices, also known as strength training equipment, are essential tools used to enhance muscular strength, endurance, and overall fitness. These devices work by providing resistance against muscle contraction, challenging the muscles to adapt and grow stronger over time. Resistance exercise is a key component of a well-rounded fitness routine and offers numerous benefits, including increased bone density, improved metabolism, and enhanced physical performance.

Resistance exercise devices come in various forms, including resistance bands, kettlebells, medicine balls, suspension trainers, and more. Each device offers unique benefits and can be used for specific exercises or as part of a comprehensive workout routine. Whether in a gym or a home setting, incorporating these devices into a fitness regimen can lead to significant improvements in strength, muscle tone, and overall physical health. As with any exercise program, it is essential to use resistance exercise devices with proper form and technique to maximize benefits and minimize the risk of injury.

One of the most common types of resistance exercise devices is free weights, such as dumbbells and barbells. The versatility of free weights allows for a wide range of exercises that target different muscle groups. Dumbbells are handheld weights available in various sizes, making them suitable for people of all fitness levels. Barbells, on the other hand, consist of a long bar with weighted plates on each end and are often used for compound exercises like squats and deadlifts.

Resistance exercise machines are another popular category of devices commonly found in home gyms and fitness centers. These machines use a system of cables, pulleys, and weight stacks to provide resistance during exercises. Resistance can also be provided using a motor and gearbox that create a replacement for weight stacks. The advantage of resistance machines is that they offer controlled movement and can be safer for beginners or individuals recovering from injuries. They can also allow for isolated targeting of specific muscles.

In recent years, resistance exercise devices have seen innovations that incorporate technology and data tracking features. Smart resistance machines often come with built-in screens or connect to fitness apps, providing users with real-time feedback, exercise guidance, and performance metrics. This integration of technology has made resistance training more engaging and personalized, catering to the needs of individuals with different fitness goals. However, current electric resistance exercise devices can lack large enough resistance to create an effective resistance for training. Additionally, the spool mechanism of current devices can allow for resistance cords to become tangled during use.

Accordingly, there is a need for an electric resistance exercise device with high levels of resistance and an organized cord mechanism.

### SUMMARY

In concordance with the instant disclosure, a fitness device, including an electric resistance exercise device with high levels of resistance and an organized cord mechanism, has surprisingly been discovered.

The present technology provides a fitness device for use by a user. The fitness device can include a resistance assembly including a spool, a motor, a gearbox, a pulley system, and a cord. The spool can include a first end and a second end. The motor can be selectively engageable with the spool and can be disposed adjacent to the first end of the spool. The motor can be configured to generate a resistance force. The gearbox can be disposed between the motor and the spool. The pulley system can be disposed adjacent to the second end of the spool. The cord can be disposed on the spool and the pulley system and can be configured to be wound and unwound in a single layer on the spool when pulled by the user. The pulley system can include a first pulley and a ball joint. The first pulley can be disposed adjacent to the spool and can be configured to receive the cord. The ball joint can include an opening therethrough. The opening can be configured to receive the cord.

The present disclosure further provides a method for using a fitness device by a user. The fitness device of the present disclosure can be provided. The fitness device can be positioned in desired location and orientation for working out by the user. The fitness device can be secured in a selected position. An exercise setting can be adjusted on the fitness device. The user can selectively engage the cord and begin exercising.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a top perspective view of a fitness device;

FIG. 2 is a bottom perspective view thereof;

FIG. 3 is a front elevational view thereof;

FIG. 4 is a top plan view thereof;

FIG. 5 is a bottom plan view thereof;

FIG. 6 is a right-side elevational view thereof;

FIG. 7 is a top perspective view of a portion of the fitness device of FIG. 1 depicted with a cover removed;

FIG. 8 is a top perspective view of the portion of the fitness device of FIG. 1 depicted with the cover and a battery removed;

FIG. 9 is a rotated top perspective view of the portion of the fitness device of FIG. 1 depicted with the cover and a battery removed;

FIG. 10 is an environmental view of the fitness device in use;

FIG. 11A is a top perspective view of the portion of the fitness device of FIG. 1 depicted without the cover illustrating a cord unwinding from a spool;

FIG. 11B is a top perspective view of the portion of the fitness device of FIG. 1 depicted without the cover illustrating the cord winding onto the spool;

FIG. 12A-12C is an illustration of a stepwise progression of the cord winding upon the spool;

FIG. 13 is a top perspective of the fitness device including a job dial according to one embodiment;

FIG. 14 is a top perspective of the fitness device in a storage mode;

FIG. 15 is a schematic view of the fitness device including a jog dial, according to one embodiment;

FIG. 16 is a schematic view of the fitness device including a voice capture module, according to another embodiment;

FIG. 17 is a schematic view of the fitness device including a programmable device, according to one embodiment;

FIG. 18 is a flow diagram of a method of using a fitness device by a user;

FIG. 19 is a top perspective view of the spool and a pulley system;

FIG. 20 is a side elevational view of the spool and the pulley system;

FIG. 21 is a cross-sectional view of the pulley system taken at A-A of FIG. 20;

FIG. 22 is a top perspective view the fitness device without a pulley system, according to one embodiment of the present disclosure; and

FIG. 23 is a front elevational view of thereof.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

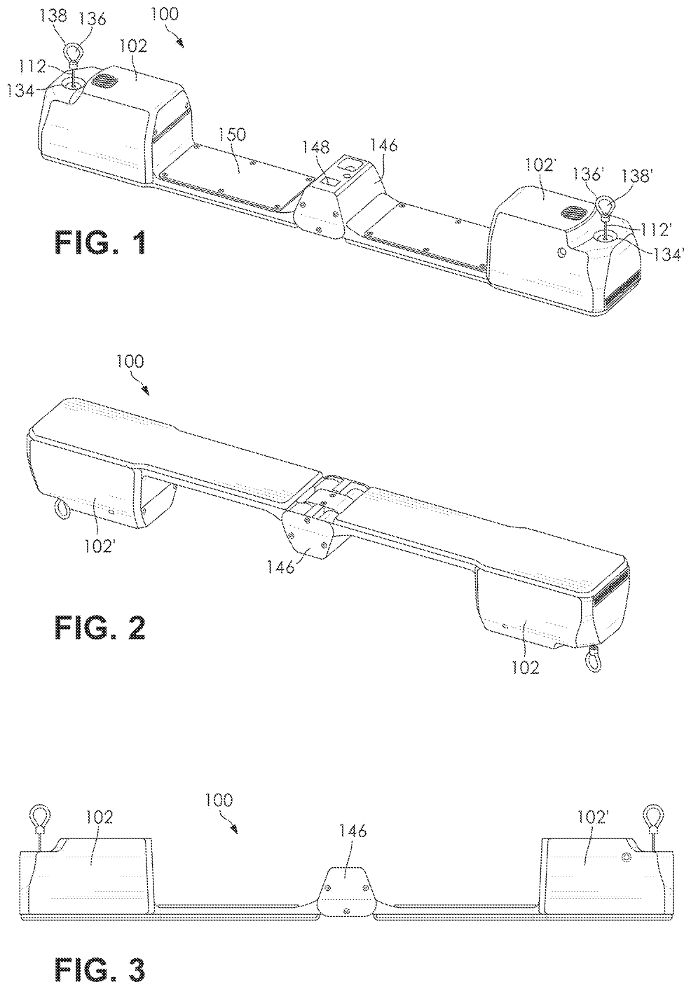

The present disclosure provides a fitness device 100 for use by a user including a resistance assembly 102, shown generally in FIGS. 1-17. The resistance assembly 102 can include a spool 104, a motor 106, a gearbox 108, a pulley system 110, and a cord 112. Advantageously, the shape of the spool 104 included in the resistance assembly 102 can militate against the cord 112 becoming tangled on the spool 104 during unwinding and winding and therefore provide a more efficient workout for the user. Additionally, the fitness device 100 can provide the user with high levels of resistance in a compact and light-weight fitness device.

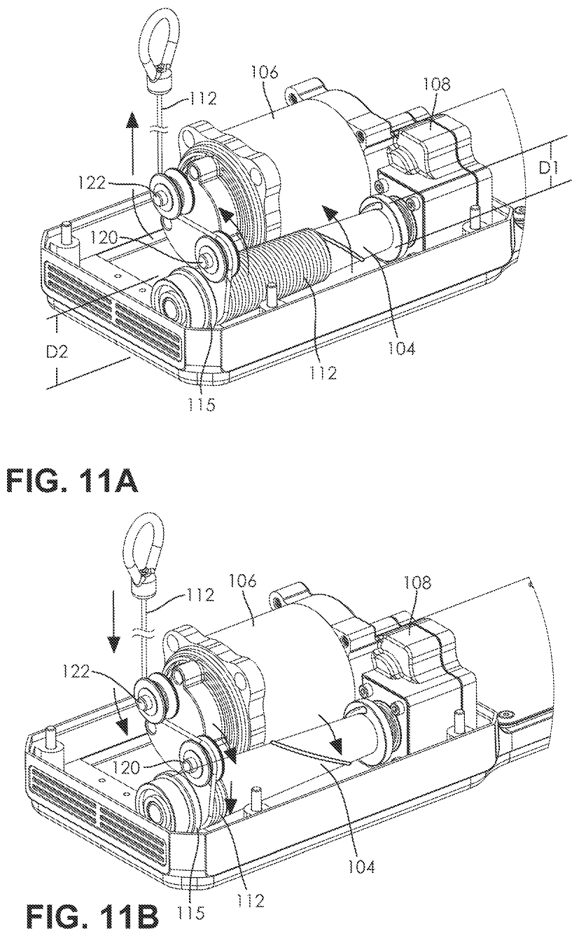

As shown in FIGS. 11A-11B, the spool 104 can be frustoconical in shape such that the spool 104 has a first end 114 and second end 116. The cord 112 can be coupled to the spool 104 at the first end 114. The first end 114 can have a diameter (D1) less than the diameter (D2) of the second end 116. This feature can allow for the cord 112 to wind about the spool in an orderly, neat, and efficient fashion allowing for a more productive workout for the user. Advantageously, the frustoconical nature of the spool 104 facilitates with the cord 112 self-aligning on the spool 104 without entanglement during rewinding. Desirably, the spool 104 allows for the user to experience a smooth pull of the cord 112 compared to pulling an unevenly wound cord 112 which would result in a jerky feeling during the workout. Further, the frustoconical shape militates against the cord 112 becoming tangled and clasped when the cord 112 is pulled by the user. In certain embodiments, the cord 112 can be wound about the spool 104 in a single layer to militate against the cord collapsing on the spool 104 resulting in a jerky, unsmooth pull of the cord 112 while in operation.

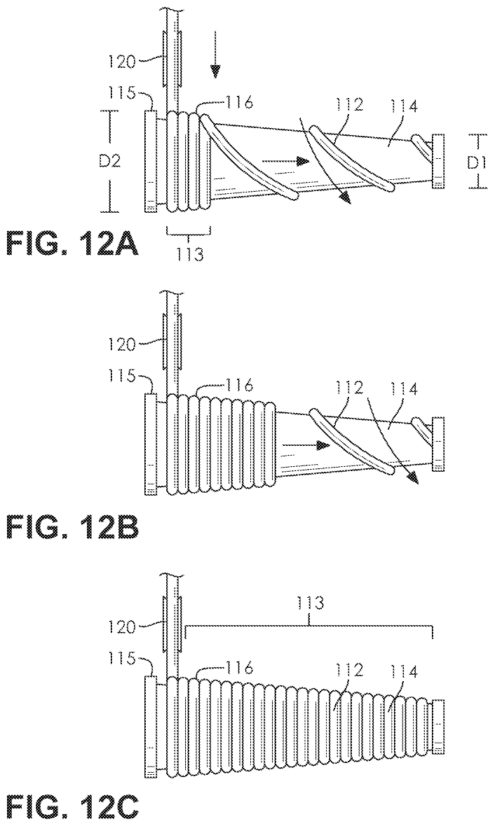

With reference to FIGS. 12A-12C, the spool 104 can include a ridge 115. The ridge 115 can militate the cord 112 winding onto the spool 104 in a direction opposite the first end 114. In operation where the cord 112 is winding upon the spool 104, and as shown in FIG. 12A, the cord 112 can begin winding upon the spool 104 in a single layer, winding from the second end 116 to the first end 114 in a bundle 113. With reference to FIG. 12B, as the cord 112 continues to be wound upon the spool 104, the bundle 113 is pushed from the second end 116 to the first end 114 until the bundle 113 occupies the entire length of the spool 104, as shown in FIG. 12C.

The spool 104 can be formed from a solid material. The solid material can allow for the spool 104 to be stable and durable as it is spun to unwind and rewind the cord 112. As non-limiting examples, the spool 104 can be formed from various polyolefins and mixtures thereof, polypropylene, high density polyethylene (HDPE), and/or polyethylene terephthalate (PET). Alternatively, the spool 104 can be formed of metal, wood, or ceramic, as examples. One of ordinary skill in the art can select other suitable materials for forming the spool 104 within the scope of the present disclosure.

With reference to FIG. 8, the motor 106 can be selectively engageable with the spool 104 and configured to generate a resistance force. The motor 106 can be disposed adjacent to the first end 114 of the spool 104 and can be configured to rotate the spool 104 in either a forward or reverse direction, depending upon whether the cord 112 is being wound or unwound upon the spool 104. In certain embodiments, the gearbox 108 can be an intermediary between the motor 106 and the spool 104. The motor 106 can provide variable torque to the spool 104 and in this way, provide the resistance required by the user for using the fitness device 100. As the resistance is adjusted by the user, the motor 106 can provide an instantaneous adjustment in the torque. The motor 106 can also wind the cord 112 on the spool 104 where the user ceases pulling on the cord 112. As a non-limiting example, the motor 106 can include a brushless DC (BLDC) motor. It should be further appreciated that one skilled in the art can employ a different motor 106, as desired.

The gearbox 108 can be disposed between the motor 106 and the spool 104. The gearbox 108 can be configured to increase the torque output by the motor 106. The spool 104 can be connected to an input end 118 of the gearbox 108. As one non-limiting example, a one-way bearing configured to transmit torque from the spool 104 to the gearbox 108 in a first direction when the user pulls on the cord 112 can be used to connect the spool 104 to the gearbox 108. The one-way bearing can militate against the gearbox 108 from rotating in a second direction opposite the first direction when the cord 112 is rewinding.

The gearbox 108 can be any suitable gearbox 108, as determined by one of skill in the art. In certain embodiments, a multi-stage planetary gearbox 108 having helical gears can be used to optimally transmit force. In certain more particular embodiments, the gearbox 108 can be configured to achieve a gear ratio. It should be appreciated that a skilled artisan can scale the gearbox ratio to be higher or lower, within the scope of this disclosure. It should be further appreciated that one skilled in the art can employ different technologies for the gearbox 108, as desired.

As shown in FIG. 8, the pulley system 110 can be disposed adjacent to the second end 116 of the spool 104. The pulley system 110 directs the cord 112 from the spool 104 out of the resistance assembly 102. The pulley system 110 can include a first pulley 120 and a second pulley 122 both configured to receive the cord 112. Additionally, one or more pulley mounting elements 128 can be used to secure the first pulley 120 and the second pulley 122 within the resistance assembly 102 and to militate against the cord 112 becoming misaligned or skewed as it is wound and unwound upon the spool 104. The first pulley 120 can be disposed adjacent to the spool 104 such that as the cord 112 moves from the first pulley 120 to the spool 104, or vice versa, the cord 112 remains within a plane perpendicular to the length of the spool 104. In this way, the cord 112 remains straight as it moves between the first pulley 120 and the spool 104 without being positioned at an angle. Advantageously, this can allow the cord 112 to have a smooth transition between the first pulley 120 and the spool 104 and promote the cord 112 winding and unwinding in a single layer upon the spool 104. A cover 130 can be integral with or permanently or removably connected to one or more of the pulley mounting elements 128. A top section 132 of the cover 130 can direct the cord 112 out through an exit port 134 of the pulley system 110 and the resistance assembly 102 for use by the user. It should be noted that the cover 130 and exit port 134 can allow for 360° rotation of the cord as it exits and enters the exit port 134. Advantageously, this reduces the overall friction that the cord experiences during a workout.

It should be appreciated that any number and orientation of pullies may be employed, as determined by one of skill in the art. As one non-limiting example, a straight pulley and an inclined pulley can be disposed in the resistance assembly 102 and used in concert to properly align the cord 112 with respect to the spool 104 and the exit port 134 during a variety of exercise programs.

The cord 112 can be disposed on the spool 104 and through the pulley system 110. The cord 112 can be unwound, as shown in FIG. 11A, and wound, as shown in FIG. 11B on the spool 104 when pulled by the user. The cord 112 can be fabricated using any flexible, durable material or combination of materials. Desirably, the cord 112 can be fabricated using a strong, lightweight material. A skilled artisan may determine any suitable length, diameter, and material for the cord. The cord 112 can further include an attachment means 136. The attachment means 136 can be disposed at a terminal end of the cord 112. As one non-limiting example, the attachment means 136 can be a loop 138, as shown in the figures. The loop 138 can be adapted to receive a carabiner clip, snap hook, or any other suitable connecting element disposed on a handle or any other desired accessory.

With reference to FIG. 10, a pair of handles 140 can be coupled to the attachment means 136 of the cord 112 to allow for use of the fitness device 100 by the user. Each handle of the pair of handles 140 can be ergonomically shaped to fit in the hand of the user. In operation, the user can hold the pair of handles 140 to use the fitness device 100 by pulling upward on the pair of handles 140 against the resistance force and releasing the tension on the cord 112 and pair of handles 140 to rewind the cord 112 on the spool 104.

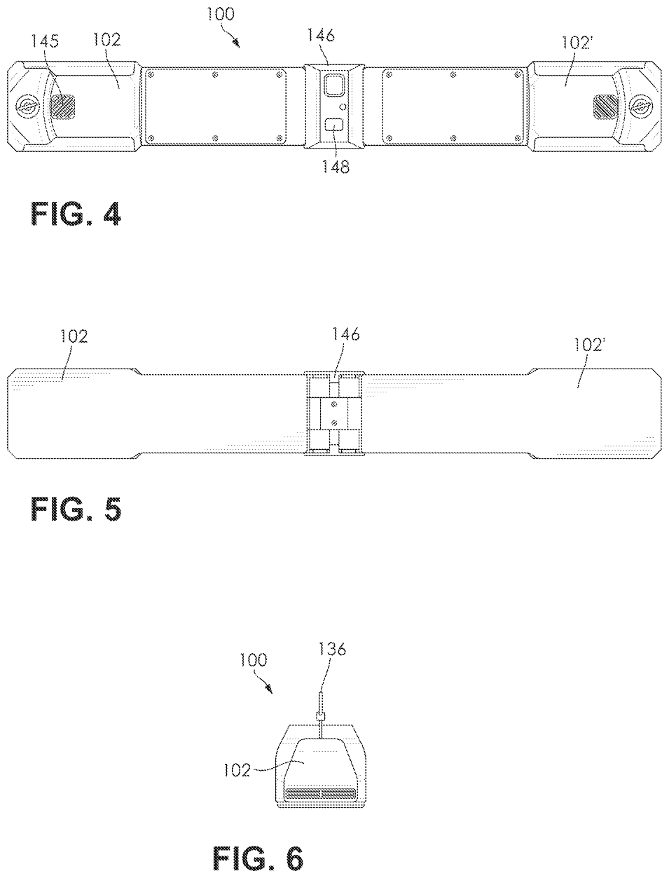

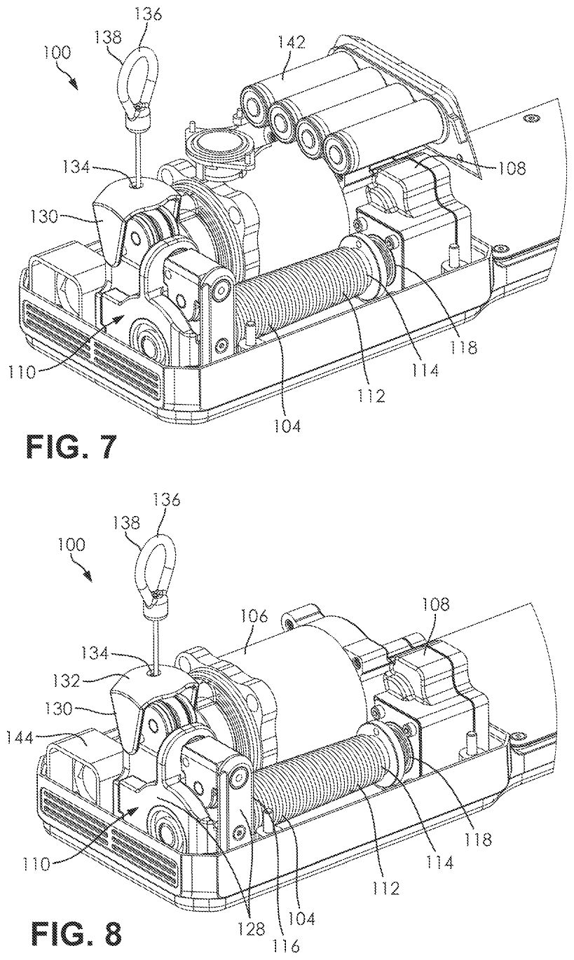

As shown in FIG. 7, the resistance assembly 102 can include a battery 142 disposed adjacent to the motor 106. Additionally, the battery 142 can be rechargeable and can be recharged by use of the fitness device 100 by the user. The battery 142 can be used to provide power to the electronic components of the fitness device 100. It should be appreciated that other power sources can also be utilized, within the scope of this disclosure. The resistance assembly 102 can further include a fan 144, shown in FIG. 8, for cooling the motor 106 while in use. The fitness device 100 can also include a built-in speaker 145, shown in FIG. 4, that can play music selected by the user. The user can utilize Bluetooth to connect the fitness device 100 to receive media such as music or podcasts, for example.

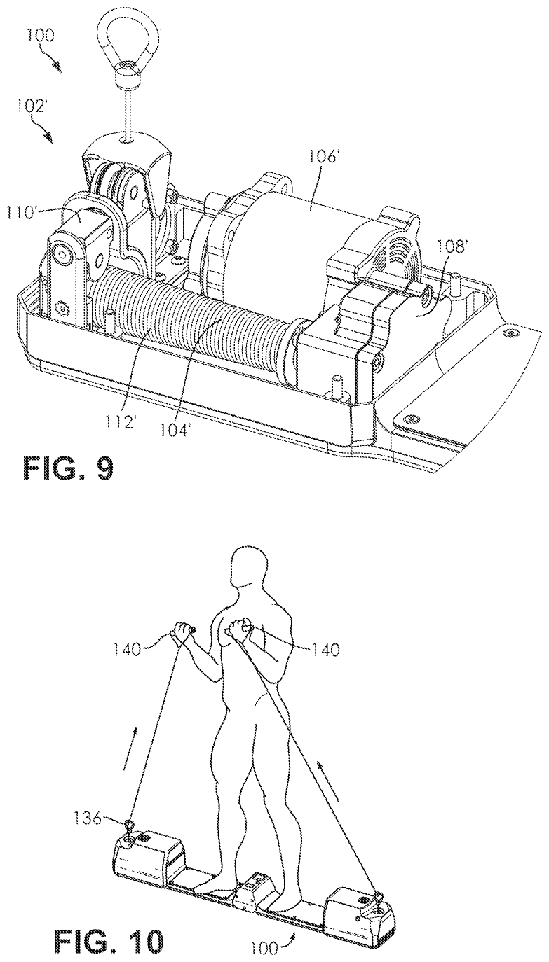

As shown in FIG. 1, the fitness device 100 can include an another resistance assembly 102′. As described hereabove, the another resistance assembly 102′ can include a spool 104′, a motor 106′, a gearbox 108′, a pulley system 110′, and a cord 112′, as shown in FIG. 9. The another resistance assembly 102′ can operate similarly to the resistance assembly 102. Advantageously, in certain embodiments of the fitness device 100 with a resistance assembly 102 and the another resistance assembly 102′, the fitness device 100 can further include a performance unit 146 in communication with both the resistance assembly 102 and the another resistance assembly 102′ and shown in FIGS. 1-5. The performance unit 146 can relay to the user an exercise setting using an arbitrary scale of resistance which can be displayed to the user on a display 148 and monitor the exercise setting.

The performance unit 146 can be disposed between the resistance assembly 102 and the another resistance assembly 102′ such that the user can place one foot between the resistance assembly 102 and the performance unit 146 and the other foot between the performance unit 146 and the another resistance assembly 102′ in operation. The performance unit 146 is centrally positioned between the resistance assembly 102 and the another resistance assembly 102′, such that the resistance assembly 102 and the another resistance assembly 102′ extend out in opposite directions from one another. To this point, each of the resistance assembly 102 and the another resistance assembly 102′ can be positioned under each of the user's arms, on either side of their body while in use.

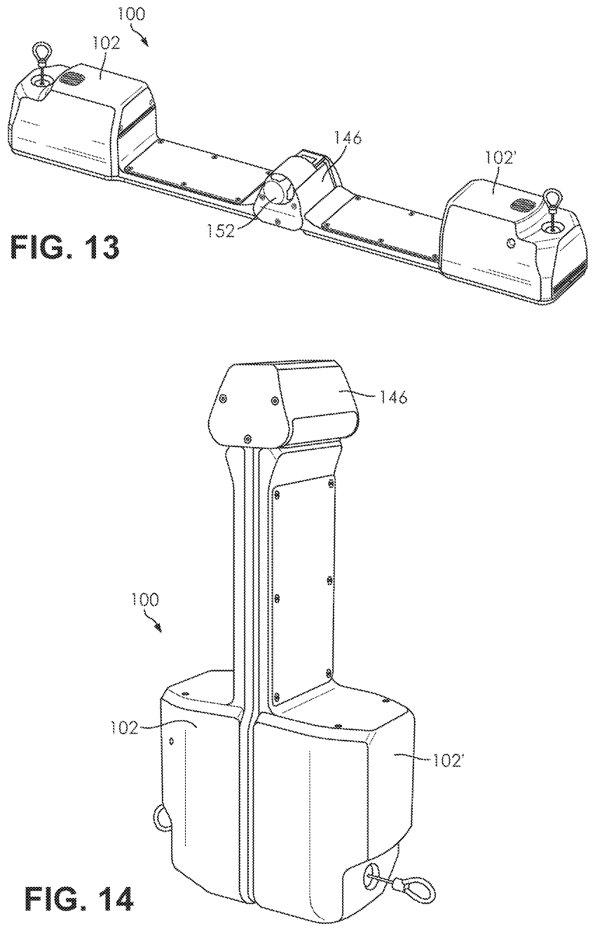

Each of the resistance assembly 102 and the another resistance assembly 102′ can be integral with the performance unit 146 or can be permanently or removably connected to performance unit 146. In certain embodiments, each of the resistance assembly 102 and the another resistance assembly 102′ can be configured to rotate with respect to the performance unit 146 between an in-use position, as shown in FIGS. 1 and 10, where the resistance assembly 102 and the another resistance assembly 102′ extend outwardly in opposite directions from the performance unit 146, and a storage position, as shown in FIG. 13, where the resistance assembly 102 and the another resistance assembly 102′ are positioned adjacent one another and extend alongside each other away from the performance unit 146. Any suitable connecting mechanism, such as a torque hinge or friction hinge, as non-limiting examples, may be used to rotatably connect each of the resistance assembly 102 and the another resistance assembly 102′ to the performance unit 146.

In certain more particular embodiments, each of the resistance assembly 102 and the another resistance assembly 102′ can be coupled to the performance unit 146 by a footboard 150, as shown in FIG. 1. The footboard 150 can be permanently or removably connected to the performance unit 146, the resistance assembly 102, and/or the another resistance assembly 102′. The footboard 150 can be made from any suitable material or combination of materials, as determined by one of skill in the art. As non-limiting examples, the footboard 150 can be fabricated using plastic, metal, or polycarbonate. The footboard 150 can include a material and/or surface texture providing friction to stabilize the user when the fitness device 100 is in use.

In certain more particular embodiments, mounting equipment (not shown) can be integral with or permanently or removably connected to one or more of the performance unit 146, the resistance assembly 102, and the another resistance assembly 102′. Mounting equipment can include clamps, straps, and mounting screws, as non-limiting examples. Mounting equipment can be configured to removably or permanently secure the fitness device 100 to any surface or object in any desired orientation. A person of skill in the art may employ any suitable mounting equipment, as desired. In this way, the mounting equipment can allow the fitness device 100 to be mounted to various horizontal, vertical, and inclined surfaces to change the angle and/or direction of the movement of the cord 112 relative to a position of the user.

The performance unit 146, the resistance assembly 102, and/or the another resistance assembly 102′ can be manufactured from wood, metal, plastic, and/or a composite. However, it should be appreciated that a skilled artisan may employ different materials for constructing the performance unit 146, the resistance assembly 102, and/or the another resistance assembly 102′ as desired.

With continued reference to FIGS. 13 and 15, the performance unit 146 can include a jog dial 152 configured to run or modify the exercise setting of the resistance assembly 102 specified by the user. It should be appreciated that, in certain embodiments, the jog dial 152 can be used to adjust an exercising setting, such as increasing or decreasing the resistance, of the resistance assembly 102.

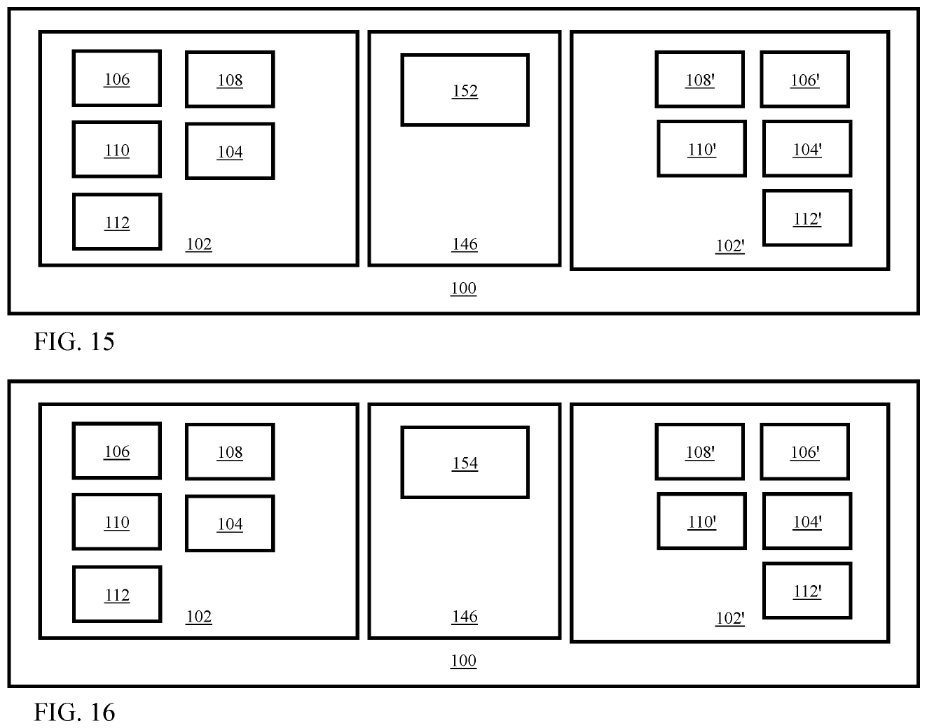

Alternatively, and with reference to FIG. 16, the performance unit 146 can include a voice capture module 154 configured to run or modify the exercise setting of the resistance assembly 102 specified by the user. The fitness device 100 can also include a microphone (not shown) configured to enable the voice capture module 154. It should be appreciated that, in certain embodiments, the voice capture module 154 can be used to adjust the exercising setting, such as increasing or decreasing the resistance, of the resistance assembly 102.

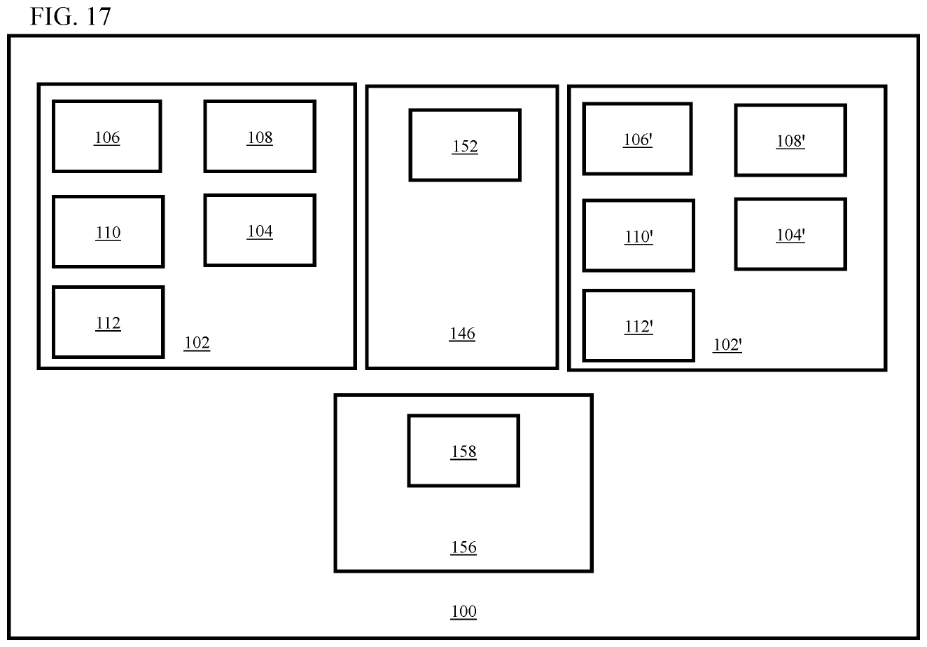

In certain embodiments, and with reference to FIG. 17, the fitness device 100 can include a programmable device 156 configured for wireless communication (e.g., short range wireless Bluetooth, internet or cloud-based communication, cellular network, and the like) with the resistance assembly 102 and/or the performance unit 146. The programmable device 156 can include a processor and a non-transitory computer readable medium. The non-transitory computer readable medium can include instructions configured to permit the user to remotely run or modify an exercise setting of the resistance assembly 102 specified by the user. It should be appreciated that, in certain embodiments, the programmable device 156 can be configured to operate directly with the resistance assembly 102 directly to modify the exercise setting without the relaying the modification to the performance unit 146.

The programmable device 156 can be further be configured to provide a graphical user interface 158 feature configured to automatically adjust a position of the jog dial 152 disposed on the performance unit 146 according to a manual manipulation of the graphical user interface 158 feature provided by a user. For example, the user can move a slider on the graphical user interface 158 of the software application and the jog dial 152 rotates increasing or decreasing resistance in the fitness device 100. Other types of graphical user interface 158 features for adjusting the position of the jog dial 152 can also be used, as desired.

In operation, the user places the fitness device 100 on the floor and stands with one foot between the resistance assembly 102 and the performance unit 146 and the other foot between the performance unit 146 and the another resistance assembly 102′. The body weight of the user can keep the fitness device 100 stable. The pair of handles 140 can be attached to the attachment means 136, one handle on the attachment means 136 of the resistance assembly 102 and another handle on the second attachment means 136′ of the another resistance assembly 102′. The user pulls on the cord 112 with the help of the pair of handles 140. The cord 112 can offer resistance, supplied by the motor 106, while the user pulls on it. As described hereinabove, the amount of resistance can be controlled by the performance unit as selected by the user.

Internally, the spool 104 connects to the motor 106 via the gearbox 108. The motor 106 offers a variable torque to the spool 104. The separate motor 106, gearbox 108 and spool 104 allows the user to seamlessly switch from working out with one handle to two handles, as desired. As described hereinabove, the torque can be adjusted to any value instantaneously. For example, there can be force when pulling, but very little force when the cord 112 is wound back, very little force when user pulls, but high force on the way down, or a decrease in weight as the cord 112 is pulled up. When the user pulls on the cord 112, the spool 104 rotates against the resistance offered by the motor 106 and unwinds the cord 112. When the user stops pulling on the cord 112, the motor 106 winds the cord 112 back onto the spool 104.

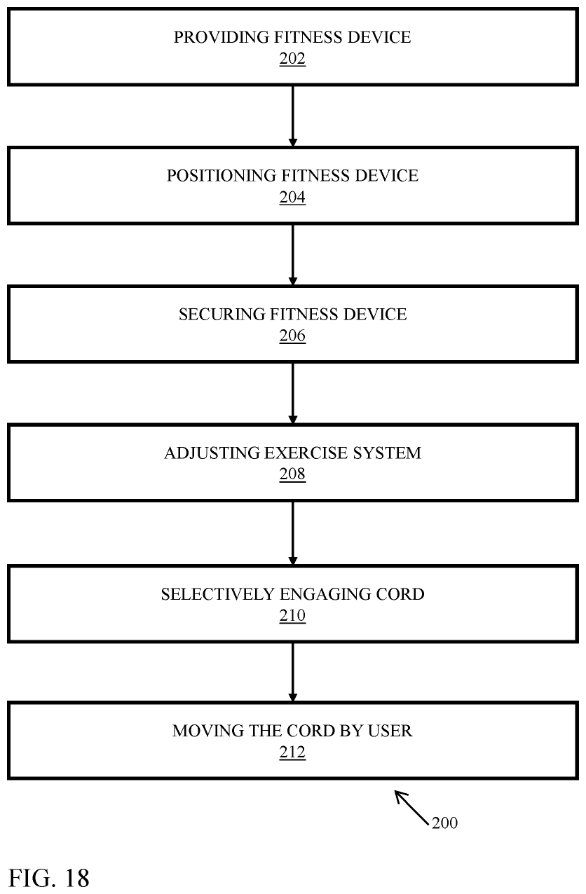

The present disclosure further provides a method 200 for using a fitness device by a user, as depicted in FIG. 18. In a step 202, a fitness device 100 of the present disclosure as described hereinabove, can be provided. The fitness device 100 can be positioned in a desired location and orientation for working out by the user in a step 204. In a step 206, the fitness device 100 can be secured in a selected position. An exercise setting can be adjusted on the fitness device in a step 208. As described hereinabove, the fitness device 100 can further include a jog dial 152 configured to run or modify the exercise setting of the resistance assembly 102 specified by the user. Alternatively, the fitness device 100 can include a voice capture module 154 configured to run or modify the exercise setting of the resistance assembly 102 specified by the user. In yet another embodiment, the fitness device 100 can include a programmable device 156 configured for wireless communication with the resistance assembly 102. The programmable device 156 can include a processor and a non-transitory computer readable medium. The non-transitory computer readable medium can include instructions configured to permit the user to remotely run or modify an exercise setting of the resistance assembly specified by the user. In a step 210, the user can selectively engage the cord 112 and begin exercising. The user can move the cord such that the cord is one of wound and unwound on the spool in a step 212.

Advantageously, the user may adjust the position and orientation of the fitness device 100, as well as any settings relating to resistance, audio, visual, tracking, or any other customizable features, in order to attain a full body workout. The fitness device 100 is lightweight and compact in both the in-use and the storage position and is thereby easy to use, setup, transport, and store. According to certain embodiments, the fitness device 100 can weigh less than ten (10) pounds. It should be appreciated that the fitness device 100 can be secured in place using only the user's body weight, thereby allowing the user to operate the fitness device without any set up or additional equipment and in any location large enough to fit the user. It should be further appreciated that the fitness device 100 can also be secured to any surface using mounting equipment or weight from an object, as needed. Advantageously, the mounting equipment can be used to affix the fitness device 100 to walls, doors, and benches, as non-limiting examples. Desirably, this can allow the user to perform exercises programs with the fitness device 100 in an elevated or otherwise unconventional position or location.

The fitness device 100 can be portable and adaptable, and can be used indoors, outdoors, at home, at work, on the go, and on demand. Using the fitness device 100 in a variety of positions and orientations allows the user to exercise a variety of muscle groups in a variety of different ways. Likewise, using the fitness device 100 in combination with a variety of accessories and with a variety of training applications allows the user to create customized, inventive, and fun exercise programs.

Advantageously, the fitness device 100 is useful for any fitness level, beginner to expert. Beginner users may select zero resistance or a low level of resistance while using the fitness device 100. Expert users may increase resistance over time, as needed. The user avoids purchasing additional equipment such as free weights and adding and removing additional equipment during use of the fitness device 100. In certain more particular embodiments, the fitness device 100 can provide up to or more than thirty-five kilograms of resistance.

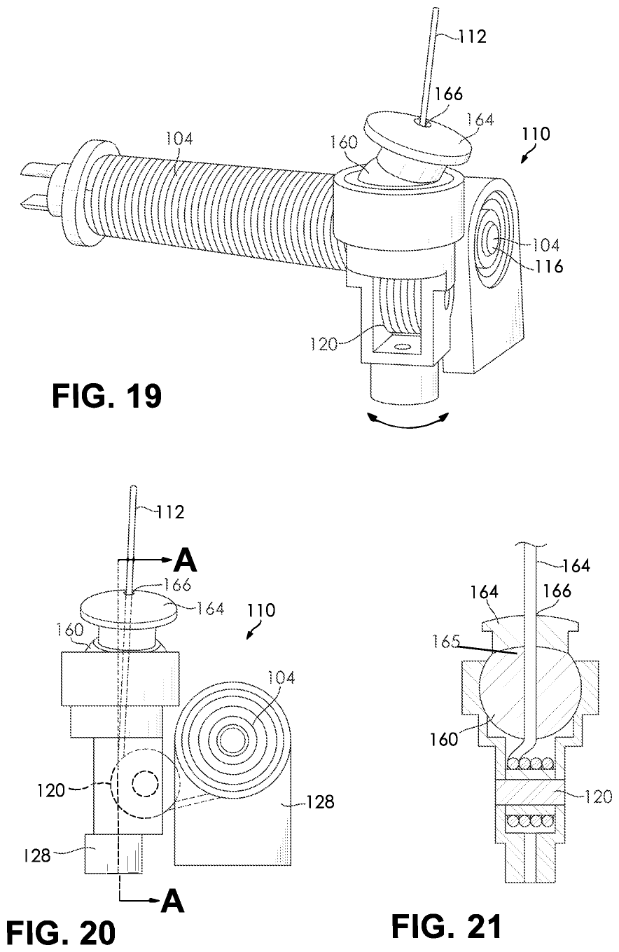

In another embodiment shown in FIGS. 19 and 20, the pulley system 110 can be disposed adjacent to the second end 116 of the spool 104. The pulley system 110 directs the cord 112 from the spool 104 out of the resistance assembly 102. The pulley system 110 can include the first pulley 120 and a ball joint 160. The first pulley 120 can be disposed adjacent to the spool 104 and can be configured to receive the cord 112. The first pulley 120 can be disposed adjacent to the spool 104 such that as the cord 112 moves from the first pulley 120 to the spool 104, or vice versa, the cord 112 remains within a plane perpendicular to the length of the spool 104. In this way, the cord 112 remains straight as it moves between the first pulley 120 and the spool 104 without being positioned at an angle. Advantageously, this can allow the cord 112 to have a smooth transition between the first pulley 120 and the spool 104 and promote the cord 112 winding and unwinding in a single layer upon the spool 104. Referring back to FIG. 8, the singular mounting element 128 can be used to secure the first pulley 120 and ball joint 160 within the resistance assembly 102 and can militate against the cord 112 becoming misaligned or skewed as it is wound and unwound upon the spool 104. Alternatively and as shown in FIG. 20, several mounting elements 128 can be used to mount the pully system and the spool. The mounting element 128 can also move within the resistance assembly 102 allowing for greater rotation of the cord 112 by the user during an exercise session, as shown in FIG. 19. The ball joint 160 can include an opening 165 therethrough. The opening 165 can be configured to receive the cord 112. The ball joint 160 can allow for rotation of the cord 112 in all directions. A pivot cover 164 can be integral with or permanently or removably connected to one or more of the pulley mounting elements 128 or the ball joint 162, as shown in FIG. 20, where the pivot cover can include a hole 166 therethrough for receiving the cord 112. The pivot cover 164 can direct the cord 112 out through the exit port 134 of the pulley system 110 and the resistance assembly 102 for use by the user. It should be noted that the pivot cover 164 and exit port 134 can allow for greater rotation of the cord 112 as it exits and enters the exit port 134. Advantageously, this reduces the overall friction that the cord 112 experiences during a workout.

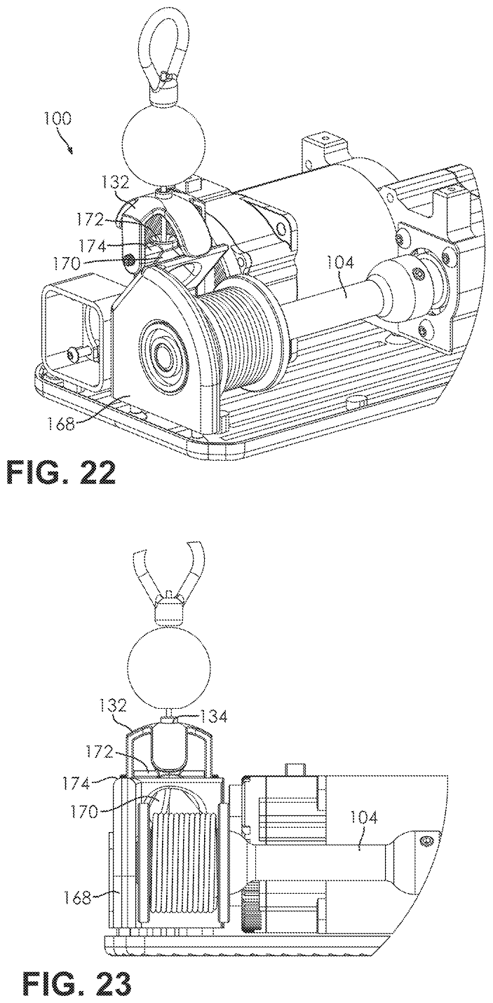

Alternatively, and as shown in FIGS. 22-23, the fitness device 100 can include a funnel member 168 instead of a pulley system 110. The funnel member 168 can be disposed on the second end 116 of the spool 104 and can act as a support for the spool 104, as shown in FIG. 22. The funnel member 168 can include a funnel 170 disposed on an upper portion of the funnel member 168. The funnel 170 can be shaped as an upside-down funnel with a lip 172 at the base 174 of the funnel 170. The lip 172 of the funnel 170 can direct the cord 112 as it exits the funnel member 168. The funnel 170 can provide a small and predictable area of contact with the cord 112 and thereby reduce the friction felt by the cord 112 as the cord 112 moves in and out of the funnel member 168 and on and off of the spool 104 during operation of the fitness device 100.

It should be appreciated that the funnel member 168 can be formed of a rigid material. As a non-limiting example, the funnel member 168 can be formed of plastic. As a preferred example, the funnel member 168 can be formed of metal to act as an additional support for the spool 104 and to increase the durability to the funnel member 168. A skilled artisan can select a suitable rigid material within the scope of the present disclosure.

As described hereinabove, the cover 130 can be integral with or permanently or removably connected to one or more of the pulley mounting elements 128. A top section 132 of the cover 130 can direct the cord 112 out through an exit port 134 of the resistance assembly 102 for use by the user. It should be noted that the cover 130 and exit port 134 can allow for 60° rotation of the cord as it exits and enters the exit port 134, as shown in FIG. 24. Advantageously, this reduces the overall friction that the cord experiences during a workout.

With continued reference to FIGS. 22-23, the spool 104 can be cylindrical in shape such that the spool 104 has a first end 114 and second end 116. The cord 112 can be coupled to the spool 104 at the first end 114. The first end 114, the second end 116, and the portion of the spool 104 disposed between the first end 114 and the second end 116 can be substantially the same in diameter. This feature can allow for the cord 112 to wind about the spool in an orderly, neat, and efficient fashion allowing for a more productive workout for the user and can allow for multi-layering of the cord 112 on the spool 104. Desirably, the spool 104 allows for the user to experience a smooth pull of the cord 112 compared to pulling an unevenly wound cord 112 which would result in a jerky feeling during the workout.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A fitness device for use by a user, comprising:
a resistance assembly including:
a spool;
a motor selectively engageable with the spool, the motor configured to generate a resistance force when engaged with the spool;
a cord configured to be wound and unwound on the spool in multiple layers in response to a movement by the user; and
a funnel member disposed adjacent to the spool and having a funnel configured to receive the cord therethrough and direct the cord out of the funnel member.

2. The fitness device of claim 1, wherein the resistance assembly further includes a gearbox coupling the spool to the motor, the gearbox transferring the resistance force from the motor to the spool when engaged with the spool, and the gearbox altering a rotational ratio between the motor and the spool.

3. The fitness device of claim 1, further including a pivot cover disposed adjacent to the funnel member, the pivot cover including a hole therethrough for receiving the cord.

4. The fitness device of claim 1, wherein the funnel member includes a lip disposed adjacent to the funnel.

5. The fitness device of claim 1, further including an attachment means configured to couple to the cord.

6. The fitness device of claim 1, further including an another resistance assembly.

7. The fitness device of claim 6, further including a performance unit for monitoring an exercise setting of the resistance assembly, the performance unit disposed between the resistance assembly and the another resistance assembly.

8. The fitness device of claim 7, wherein the performance unit includes a jog dial configured to run or modify the exercise setting of the resistance assembly specified by the user.

9. The fitness device of claim 7, wherein the performance unit includes a voice capture module configured to run or modify the exercise setting of the resistance assembly specified by the user.

10. The fitness device of claim 1, further including a programmable device configured for wireless communication with the resistance assembly.

11. The fitness device of claim 10, wherein the programmable device includes a processor and a non-transitory computer readable medium, the non-transitory computer readable medium including instructions configured to permit the user to remotely run or modify an exercise setting of the resistance assembly specified by the user.

12. The fitness device of claim 1, wherein the spool is frustoconical.

13. The fitness device of claim 1, wherein the resistance assembly further includes a battery.

14. The fitness device of claim 13, wherein the battery is recharged by use of the fitness device by the user.

15. The fitness device of claim 1, wherein the resistance assembly further includes a fan, whereby the fan cools the motor in operation.

16. The fitness device of claim 1, further including a jog dial configured to run or modify an exercise setting of the resistance assembly specified by the user.

17. The fitness device of claim 1, further including a voice capture module configured to run or modify an exercise setting of the resistance assembly specified by the user.

18. A fitness device for use by a user, comprising:
a resistance assembly including:
a spool having a first end and a second end, the first end having a diameter less than a diameter of the second end;
a motor selectively engageable with the spool, the motor configured to generate a resistance force when engaged with the spool;
a cord configured to be wound and unwound on the spool in a single layer in response to a movement by the user; and
a pulley system having a first pulley and a ball joint, the first pulley disposed adjacent to the spool and configured to receive the cord, the ball joint having an opening therethrough configured to receive the cord.

19. A method of using a fitness device by a user, comprising:
providing a fitness device including a resistance assembly including:
a spool having a first end and a second end, the first end having a diameter less than a diameter of the second end;
a motor selectively engageable with the spool, the motor configured to generate a resistance force when engaged with the spool;
a cord configured to be wound and unwound on the spool in a single layer in response to a movement by the user; and
a pulley system having a first pulley and a ball joint, the first pulley disposed adjacent to the spool and configured to receive the cord, the ball joint having an opening therethrough configured to receive the cord; and
moving the cord by the user so that the cord is one of wound and unwound on the spool.

20. The method of using a fitness device of claim 19, further comprising a member selected from a group consisting of:
positioning the fitness device in a desired location and orientation;
securing the fitness device in a selected position;
adjusting an exercise setting on the fitness device;
selectively engaging the cord; and
combinations thereof.
